(19) United States
(12) Patent Application Publication
(10) Pub. No.: US 2009/0232365 A1
(43) Pub. Date: Sep. 17, 2009

(54) METHOD AND DEVICE FOR FACE RECOGNITION

(75) Inventors: Rikard Berthilsson, Furulund (SE); Erik Olausson, Malmo (SE)

Correspondence Address: FULWIDER PATTON LLP, HOWARD HUGHES CENTER, 6060 CENTER DRIVE, TENTH FLOOR, LOS ANGELES, CA, 90045, US

(73) Assignee: COGNIMATICS AB, Lund (SE)

(21) Appl. No.: 12/402,405

(22) Filed: Mar. 11, 2009

Related U.S. Application Data
(60) Provisional application No. 61/068,884, filed on Mar. 11, 2008.

(51) Int. Cl. G06K 9/00; H04M 1/00

(52) U.S. Cl. 382/118; 455/566

(57) ABSTRACT

A method, apparatus and computer readable medium for automatically recognizing a human face, which are adapted to: retrieve an image of the face; extract a number of feature patches from the image of the face; calculate a feature value for each feature patch, as a function of an image-derivate of the respective feature patch; and comparing the feature values with corresponding feature values of a number of feature patches of a reference image stored in an image database, for determining a recognition of the human face.

### CROSS-REFERENCES TO RELATED APPLICATIONS

This application claims priority from U.S. Application No. 61/068,884, filed Mar. 11, 2008 incorporated by reference in its entirety.

### BACKGROUND

The invention relates to a method, apparatus and computer readable medium for automatically recognizing a human face in an image, by comparing the image with a number of reference images.

Most research in the face recognition area has focused on very specialized environments or situations. Such situations include for example authorities who want to spot a fugitive on the subway, or a pharmaceutical company who wants to restrict access to a laboratory. The consequences of a mismatch are typically severe in these circumstances and the tolerance for errors is therefore low. The price for this low error tolerance is restrictions on input and/or reference images in the gallery that the system uses for image comparison. Typically, the systems require that either gallery images, input images or both are taken under controlled lighting conditions with a subject of the image has a neutral facial expression and is facing the camera straight on.

Today several techniques related to face recognition exist, such as Local DCT, or Discreet Cosine Transform, which divides an image of a persons face into small local regions that are handled separately. The idea is here to make the recognition system less sensitive to pose variation since the overall geometry of the face is ignored and only local geometry is considered.

Typically, face images are divided into blocks that can be overlapping or non-overlapping. DCT is performed on each block independently. The coefficients resulting from the DCT are then used as features that are representative of the face on the image. Local DCT is, among others, used by Sanderson et al. in combination with a Bayesian Classifier based on Gaussian Mixture Models, as presented in an article by Sanderson, Conrad, Bengio, Samy and Yong-sheng, Gao: “On Transforming Statistical Models for Non-Frontal Face Verification”, Pattern Recognition, No. 2, Vol. 39, 2006, pages 288-302.

Other methods exist, such as SVM, or Support Vector Machines, which are a set of training and classification methods applicable to many areas in computer vision. Input data is in these methods projected into a higher dimensionality space. During training hyper-planes are formed in this space that separates positive matches from negative matches for a face image that is compared with a number of reference images.

A principal problem when using SVM is that positive and negative examples may not be linearly separable in the given hyperspace if the variation with-in the class is greater in some aspect than the variation between classes. This is usually solved by using a so called non-linear kernel function KO to make a decision surface non-linear. A face recognition system using this strategy is described in a publication by Phillips, P. Jonathon: “Support Vector Machines Applied to Face Recognition”, Advances in Neural Information Processing Systems 11, (2007), MIT Press.

Even it there are several image recognition techniques available as of today, many are restricted with respect to pose, facial expression and lighting conditions of a facial image. Many techniques are also insufficient in case one or only a few images per person are available in a reference image gallery used for the recognition, or in case only one input image may be used for the identification of a person. Limitations in memory and processor capabilities add further difficulties for many present image recognition techniques.

### SUMMARY OF THE INVENTION

In view of the above, an objective of the invention is to achieve improved recognition rate on input face images, even if conditions like lighting, pose and facial expression in the image are not optimal, and/or if available processing and memory capabilities available for performing the recognition are limited.

Hence a method of automatically recognizing a human face is provided, the method comprising: retrieving an image of the face; extracting a number of feature patches from the image of the face; calculating a feature value for each feature patch, as a function of an image-derivate of the respective feature patch; comparing the feature values with corresponding feature values of a number of feature patches of a reference image stored in an image database, for determining a recognition of the human face.

Here, a “feature patch” is a part of the image of the face, which means that the image of the face is divided into overlapping and/or non-overlapping rectangular feature patches of different sizes and proportions. By “automatically” recognizing a human face means that the method is performed in an electronic device.

In brief, the input image may be seen as matched against an image gallery and a position vector formed that represents the differences between the input image and a gallery image. This vector is treated as a point in a multi-dimensional space. E.g. hyper-planes that have been formed in training may be used to determine if the image pair depicts the same individual or not. Of course, each image in the image gallery (reference image) is associated with a identifier of a person.

Compared to known technology, using the inventive method reduces the risk of identification mismatches when input images vary, for example in respect of pose. This is at least in part due to the use of image derivatives rather than intensity values directly, which reduces problems caused by changing lighting conditions (derivatives are practically insensitive to changes in lighting from day to night, indoor to outdoor etc).

Extracting features on a local level and not just from the entire face image has also the advantage of reducing the effects of facial expressions. For instance, if the positions of facial parts such as the eyes, nose and mouth are known, this information is used to extract local features around those parts. It should also be noted that the area around the eyes are relatively little affected by changes in facial expression. On the other hand, the geometry around the mouth may change dramatically if a person is smiling, moping, laughing or shouting.

At least three image patches may be extracted from the image of the face, wherein the feature patches are extracted from the image patches. Here, an “image patch” is, for example, an image of the whole face, an image centered around the left eye, and an image centered around the right eye. In case image patches are used each such image patch is divided into the overlapping rectangular feature patches mentioned above.

In other words, when using image patches it may be said that the invention employs at least three steps, namely i) using (light) insensitive features based on sum of derivatives, ii) splitting the image into several separate image patches operated on independently, and iii) measuring relations to hyper-planes formed by determining differences in feature values of a number of reference images (training). Having several images of a person in the gallery improves the sensitivity to pose variation, and using several images per person may also reduce the problem with other variations such as facial expression and difficult lighting conditions.

The comparing of the feature values may comprise weighting the feature values as a function of the image patches, which gives a more accurate recognition. More specifically, the weighting may be done as function of the hyper-plane.

The calculating of each feature value may comprise summarizing image derivates for the respective feature patch, which gives a rather reliable numeric representation of the facial image. Moreover, this results in a method that is less sensitive to noise and integer overflow.

The calculating of each feature value may comprise summarizing at least three image derivates for the respective feature patch.

The calculating of the feature value for each feature patch may comprise determining the integral image of the image of the face. In case the feature patches are extracted from the image patches, then the calculating of the feature value for each feature patch comprises determining the integral image of the image patch from which the feature patch was extracted. Using determination of the integral image is advantageous in that summations of the image derivatives measures may be computed very fast.

The method may comprise the step of determining a number of hyper-planes from a plurality of vectors representing differences in feature values of a number of reference images, which provides efficient recognition of a face. It should be observed that hyper-plane determination per se is known within the art and is performed according to known methods.

The comparing of the feature values may comprise determining a relationship between the hyper-planes and the features values calculated from the feature patches of the image of the face.

According to another aspect of the invention, an apparatus for automatically recognizing a human face is provided, which is configured to: retrieve an image of the face; extract a number of feature patches from the image of the face; calculate a feature value for each feature patch, as a function of an image-derivate of the respective feature patch; compare the feature values with corresponding feature values of a number of feature patches of a reference image stored in an image database, for determining a recognition of the human face.

More particularly, the apparatus may be a cellular phone.

According to a further aspect of the invention, a computer readable medium is provided, having stored thereon a computer program having software instructions which when run on a computer cause the computer to perform the steps of: retrieving an image of the face; extracting a number of feature patches from the image of the face; calculating a feature value for each feature patch, as a function of an image-derivate of the respective feature patch; comparing the feature values with corresponding feature values of a number of feature patches of a reference image stored in an image database, for determining a recognition of the human face.

The inventive apparatus and computer readable medium may comprise, be configured to execute and/or having stored software instructions for performing any of the features described above in association with the inventive method, and has the corresponding advantages.

### BRIEF DESCRIPTION OF THE DRAWINGS

Embodiments of the invention will now be described, by way of example, with reference to the accompanying schematic drawings, in which

FIG. 1 is a flow diagram of a face recognition method according to the invention,

FIGS. 2a-2c show three different image patches that can be used for feature extraction, and

FIG. 3 shows an apparatus implementing the inventive method.

### DETAILED DESCRIPTION OF THE PREFERRED EMBODIMENTS

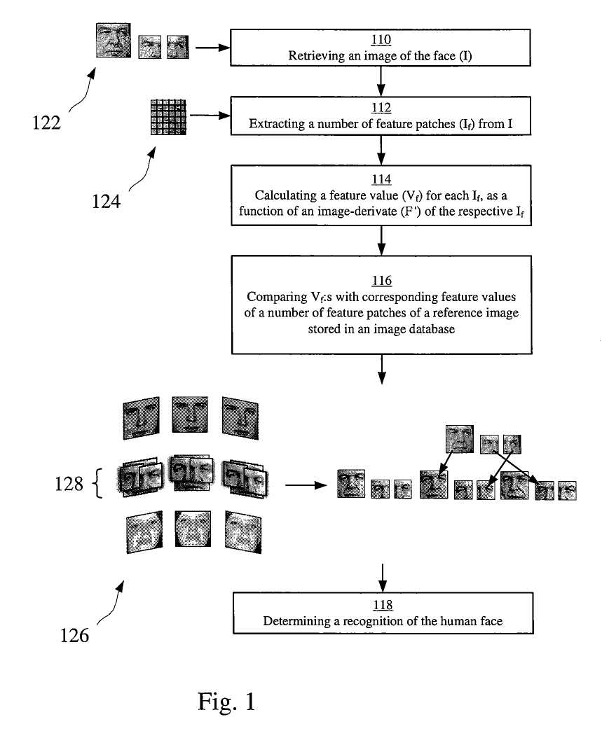

With reference to FIG. 1 the inventive method is illustrated where an image, or in this case more specifically three images 122, of a human face is retrieved 110. Next, a number of feature patches are extracted 112 from the image of the face for forming a set 124 of sub images if the images 122 (i.e. a set of feature patches is formed). These feature patches are extracted form each of the three images 122 (even if only one is illustrated). Thereafter a feature value for each feature patch is calculated 114 as a function of an image-derivate of the respective feature patch. After this the feature values are compared 116 with corresponding feature values of a number of feature patches of a reference image stored in an image database 126, and finally a recognition of the human face is determined 118 on basis of the compared feature values. When this is done a set 128 comprising three images which each are split up into three patches, resulting in a total of nine images for feature extraction.

In further detail, a black and white digital image can be represented by a matrix, such that each element in the matrix represents a pixel in the image. A low value represents a dark pixel value and a higher value represents a brighter pixel value. For a color image, usually three such matrices are used, each one representing for example one of the colors red, green or blue, respectively. Other choices or color coding may also be used. Thus, the image is seen as a function Φ:Ω→Rⁿ, where R represents the real numbers in the space, Φ is a function from the domain Ω to the n dimensional space. n=1 for black and white images and n=3 for color images and Ω⊂R² is a subset in the real plane, which is typically of rectangular shape consisting of a grid of points. By interpolation one can also let Ω be a solid rectangle in R².

As indicated, by patch is meant a portion of the entire image, or the full image (i.e. the entire image), and this image may also be represented as a function in the same way as for the entire image. One may also say that a portion of an image is cropped out to get a patch of it.

Images may be rotated, scaled, cropped and in other ways deformed according to various methods known within the art. The resulting image may then be represented as a function as given above.

In each image herein presented, the face and eye positions of a person on the image are found automatically. Using certain face positions, such as the eye positions, the images can be normalized, for example by scaling, cropping and rotating, which is referred to as preprocessing of images. The resulting image is then of a certain size (in pixels) where for example the eyes may be in predefined positions. The image may also be cropped so that only the face remains and nothing from the background.

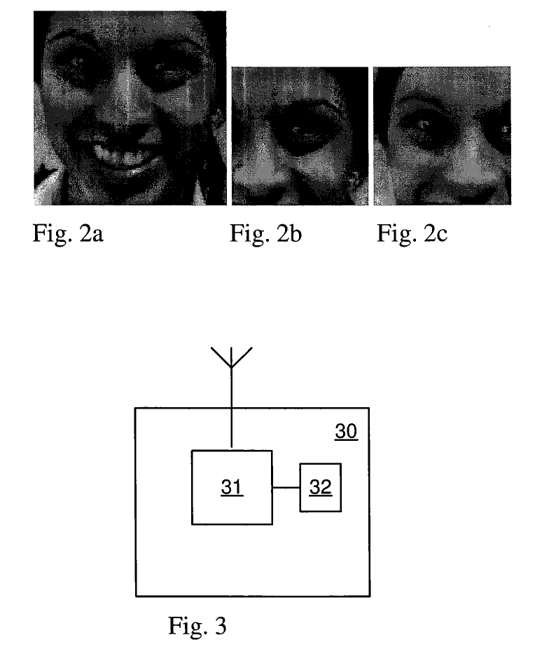

With reference to FIGS. 2a-2c, an example of three different image patches that can be used for feature extraction are shown, where FIG. 2a shows the whole face (112×112 pixels), FIG. 2b shows the right eye (80×80 pixels) and FIG. 2c shows the left eye (80×80 pixels).

As with the preprocessing step, the feature extraction from images is done in the same manner in a subsequent training, when building the gallery and when testing probe images against the gallery, i.e. a set of reference images in an image database. If certain points of the face are know such as for example the position of eyes and nose then areas around those points are cropped out in order to form new images which can be used for improving the recognition accuracy. As mentioned, three different images may be used: i) one with the whole face, ii) one centered around the left eye, and iii) one centered around the right eye.

Each such so called image patch is divided into overlapping rectangular feature patches of different sizes and proportions. In each such feature patch co, image derivatives measures (Φ′ₓ, Φ′_{y}) are calculated. Many possible derivative measures can be used like for example

$$\begin{matrix}\frac{{\sum }_{( x , y ) ∈ ω} {Φ}_{x}^{{}^{′} 2}}{{\sum }_{( x , y ) ∈ ω} {Φ}_{x}^{{}^{′} 2} + {Φ}_{y}^{{}^{′} 2}} & ( 1 ) \\ \frac{{\sum }_{( x , y ) ∈ ω} {Φ}_{y}^{{}^{′} 2}}{{\sum }_{( x , y ) ∈ ω} {Φ}_{x}^{{}^{′} 2} + {Φ}_{y}^{{}^{′} 2}} \\ and & ( 2 ) \\ \frac{{\sum }_{( x , y ) ∈ ω} {Φ}_{x}^{′} {Φ}_{y}^{′}}{{\sum }_{( x , y ) ∈ ω} {Φ}_{x}^{{}^{′} 2} + {Φ}_{y}^{{}^{′} 2}} . & ( 3 )\end{matrix}$$

Another possibility is to use

$$\begin{matrix}\frac{{\sum }_{( x , y ) ∈ ω} \vert {Φ}_{x}^{′} \vert}{{\sum }_{( x , y ) ∈ ω} \vert {Φ}_{x}^{′} \vert + \vert {Φ}_{y}^{′} \vert} & ( 4 ) \\ \frac{{\sum }_{( x , y ) ∈ ω} \vert {Φ}_{y}^{′} \vert}{{\sum }_{( x , y ) ∈ ω} \vert {Φ}_{x}^{′} \vert + \vert {Φ}_{y}^{′} \vert} & ( 5 ) \\ \frac{{\sum }_{( x , y ) ∈ ω} \vert {Φ}_{x}^{′} + {Φ}_{y}^{′} \vert - \vert {Φ}_{x}^{′} - {Φ}_{y}^{′} \vert}{{\sum }_{( x , y ) ∈ ω} \vert {Φ}_{x}^{′} \vert + \vert {Φ}_{y}^{′} \vert} , & ( 6 )\end{matrix}$$

which are less sensitive to noise and integer overflow.

For each feature patch, this will give us three measures of the “activity” in each patch in three directions, i.e. a measure on the amount of structure along the x-axis, the y-axis and the xy-direction in each feature patch. Furthermore, the feature values will not depend on the how bright or dark the image is since ratios are used. Only the structure in the feature patch is regarded.

When n feature patches in each derivative image are summed in this way, and when there is, for instance, three different derivative measure for each feature patch, it will result in a total of 3n feature values for each image patch. These values are treated as coordinates of a vector in fεR³ⁿ, where training as well as testing occurs.

The summations above may be computed very fast by using the so called integral image. Let Φ:Ω→R be an m×n pixels image, where Ω=[0,m−1]×[0,n−1] is a rectangular grid, then

$$\hat{Φ} ( x , y ) = {\sum }_{j = 0}^{x} {\sum }_{k = 0}^{y} Φ ( j , k ) \qquad ( 7 )$$

is called the integral image of Φ. It follows that the summation over the rectangle [a₁,a₂]×[b₁,b₂] can be reduced to

$${\sum }_{j = {a}_{1}}^{{a}_{2}} {\sum }_{k = {b}_{1}}^{{b}_{2}} Φ ( j , k ) = \hat{Φ} ( {a}_{1} , {b}_{1} ) + \hat{Φ} ( {a}_{b} - 1 , {b}_{2} - 1 ) - \hat{Φ} ( {a}_{1} , {b}_{2} - 1 ) - \hat{Φ} ( {a}_{2} - 1 , {b}_{1} ) \qquad ( 8 )$$

requiring only one addition and two subtractions.

The first step of a training procedure for training images is to extract feature values for each image in the training set, as described above. During training we compute the hyper-planes and this is done through optimization in a similar fashion as SVM by using positive and negative examples that are drawn from test images from which feature values are extracted. Hence, input images are paired up in every possible combination. Difference values for each image pair are calculated, for example by using

dₘₙ(j)=|fₘ(j)−fₙ(j)|, m≠n, (9)

where fₘ(j) and fₙ(j) are the j coordinate of the vectors fₘ and fₙ holding the feature values, i.e. image derivatives measures calculated according to formula (1)-(6), for image m and n respectively in the training.

This yields one new vector dₘₙ per feature space for each image pair. This operation is necessary to perform the known so called k-class problem of classifying an input image showing one of k individuals into a two-class problem: positive match or negative match.

The goal of the training procedure is to find multi-dimensional hyper-planes, w so that all (or as many as possible) of the points representing positive matches are on one side, and all representing negative matches are on the other. To simplify calculations, all negative matches are negated, thus creating one large point-group in the same “part” of the multi-dimensional space. Next each plane is defined in turn so that as few points as possible (both positive and negated negative) are outliers, i.e. fall on one wrong side of the plane.

The remaining training procedure is in essence a modified version of the Gauss-Newton algorithm for finding a minimum sum of squared values, and has some similarities with the SVM-approach described above. Given a set of feature vectors xⱼεR³ⁿ a hyper-plane wεR³ⁿ is identified so that the error

$$Q ( w ) = {\sum }_{j} {( f ( {x}_{j} , w ) )}^{2} \approx {\sum }_{j} {\{ f ( {x}_{j} , {w}_{0} ) + \frac{\partial f}{\partial w} ( {x}_{j} , {w}_{0} ) ( w - {w}_{0} ) \}}^{2} \qquad ( 10 )$$

is minimized and where the error term is approximated by the first order Taylor expansion and w₀ refers to the approximated plane from the previous iteration (or random values if it is the first iteration). In our case, f(xⱼ,w) is defined by f(xⱼ,w)=xⱼ·w−1 if xⱼ·w<1 and f(xⱼ,w)=0 otherwise. This is equivalent to only considering the outliers, i.e. positive matches and negated negative matches on the wrong side of the plane. Since the derivative f′(xⱼ,w) with respect to w is given by xⱼ, the Taylor expansion in (10) simplifies to

$$Q ( w ) = {\sum }_{j} {\{ ( {x}_{j} \cdot {w}_{0} - 1 ) + {x}_{j} \cdot Δ \}}^{2} \qquad ( 11 )$$

where Δ=(w−w₀). Since one may not control xⱼ and w₀, minimizing Q(w) is equivalent to minimizing Δ. Thus, the integral of Q(w) is set to

$$\hat{Q} ( Δ ) = {\sum }_{j} {\{ ( {x}_{j} \cdot {w}_{0} - 1 ) + {x}_{j} \cdot Δ \}}^{2} , \qquad ( 12 )$$

where now \hat{Q}(Δ)=Q(Δ+w₀), and the derivative with respect to Δ, is taken, giving

$$\frac{δ \hat{Q} ( Δ )}{δΔ} = 2 {\sum }_{j} {x}_{j} {x}_{j}^{T} Δ + 2 {\sum }_{j} ( {x}_{j} \cdot {w}_{0} - 1 ) {x}_{j} \cdot \qquad ( 13 )$$

Setting

$$\frac{δ \hat{Q} ( Δ )}{δΔ} = 0$$

and solving for Δ gives

$$Δ = - {( {\sum }_{j} {x}_{j} {x}_{j}^{T} )}^{- 1} ( {\sum }_{j} ( x {}_{j} \cdot {w}_{0} - 1 ) {x}_{j} ) . \qquad ( 14 )$$

It follows that w=w₀+Δ.

Following the Gauss-Newton method, the algorithm will iterate, each iteration producing a new approximation of w, eventually reducing the mean absolute value of Δ and the number of outliers.

Each set of iterations produces one plane, reducing the number of outliers. The number of planes produced depends on the amount and disparity of input training data and the stopping criteria.

As during the training phase, the first step in building an image gallery is to crop and normalize the images.

The preprocessing and feature extraction steps are identical to the training phase and building the gallery. Once the feature values in all feature spaces have been extracted, the actual recognition is performed by matching the probe image to each gallery image. A difference value is calculated according to (9) and treated as a point xεR^{m}, where R^{m} is the m dimensional real vector space.

In this space, the relation to hyper-planes formed in training is calculated. One way of doing this is by summing the geometric distances to all hyper-planes

$$D = {\sum }_{n} \frac{{\sum }_{j = 1}^{m} {a}_{j , n} {x}_{j}}{\sqrt{{\sum }_{j = 1}^{m} {a}_{j , n}^{2}}} \qquad ( 15 )$$

for all n planes, where a_{j,n} is the j:th coordinate of the n:th plane and xⱼ is the j:th coordinate of the position vector for our point.

In this case, the image pair with the largest value of D will be considered the best match. That is, the further our point is to the planes, in the positive direction, the more certain one may be that this is in fact a positive match.

Alternatively it is possible to use

$$D = {\sum }_{n} ( {\sum }_{j = 1}^{m} {a}_{j , n} {x}_{j} > 0 ) \qquad ( 16 )$$

as distance measure, where

$$( {\sum }_{j = 1}^{m} {a}_{j , n} {x}_{j} > 0 )$$

is 1 if the inequality is true and 0 if it is false.

To handle the cases where different image patches give rise to the best match, a weighting function can used which combines match values from all feature spaces. In the cases where three images in feature extraction are used: one covering the whole face, one centering around the left eye and one centering around the right eye, an example of the weighting-function might be

$${D}_{tot} = γ {D}_{wf} + \frac{1 - γ}{2} {D}_{re} + \frac{1 - γ}{2} {D}_{le} , \qquad ( 17 )$$

where D_{wf}, Fᵣₑ, and Dₗₑ are the distance measures in the whole face, right eye and left eye feature spaces respectively and 0≦γ≦1 specifies how much weight should be given to whole face and eyes, respectively.

Alternatively it is possible to use

$${D}_{tot} = w ( {D}_{wf} > {σ}_{wf} ) + \frac{1 - w}{2} ( {D}_{re} > {σ}_{re} ) + \frac{1 - w}{2} ( {D}_{le} > {σ}_{le} ) \qquad ( 18 )$$

with some constants σ_{wf}, σᵣₑ and σₗₑ.

If there is more than one gallery image per individual, some combination of the distance values for the different feature spaces have to be calculated. For example, the optimal value can be calculated over all reference images for every possible match.

In that case, (17) and (18) are modified to

$$\begin{matrix}{D}_{tot} = w {max}_{nRef} ( {D}_{wf} ) + \frac{1 - w}{2} {max}_{nRef} ( {D}_{re} ) + \frac{1 - w}{2} {max}_{nRef} ( {D}_{le} ) \\ and & ( 19 ) \\ {D}_{tot} = w {max}_{nRef} ( {D}_{wf} > {σ}_{wf} ) + \frac{1 - w}{2} {max}_{nRef} ( {D}_{re} > {σ}_{re} ) + \frac{1 - w}{2} {max}_{nRef} ( {D}_{re} > {σ}_{le} ) & ( 20 )\end{matrix}$$

respectively and optimization over all nRef reference images of this individual in the gallery is performed.

With reference to FIG. 3, in apparatus in the form of a cellular phone 30 implementing the invention is illustrated. The phone 30 comprises a computer 31 in the form of microprocessor suitable for mobile devices. A computer readable medium 32 is connected to the computer 31 and on the medium 32 is software instructions for performing the inventive method stored together with a number of reference images and an image of a face of a person to be identified.

The above described method may just as well be implemented in e.g. present video surveillance systems, but also in any other electronic device configured to handle images, as long as the electronic device has a small processor which in turn has access to a memory storage. Then it is only a matter of implementing software instructions which when run in the electronic device cause the apparatus to perform the above described method.

Software instructions, i.e. a computer program code for carrying out methods performed in the previously discussed apparatus may for development convenience be written in a high-level programming language such as Java, C, and/or C++ but also in other programming languages, such as, but not limited to, interpreted languages. Some modules or routines may be written in assembly language or even micro-code to enhance performance and/or memory usage. It will be further appreciated that the functionality of any or all of the functional steps of the method may also be implemented using discrete hardware components, one or more application specific integrated circuits, or a programmed digital signal processor or microcontroller.

The invention has mainly been described above with reference to a few embodiments. However, as is readily appreciated by a person skilled in the art, other embodiments than the ones disclosed above are equally possible within the scope of the invention, as defined by the appended patent claims.

Generally, all terms used in the claims are to be interpreted according to their ordinary meaning in the technical field, unless explicitly defined otherwise herein. Hence all references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

1. A method of automatically recognizing a human face, comprising:
retrieving an image of the face,
extracting a number of feature patches from the image of the face,
calculating a feature value for each feature patch, as a function of an image-derivate of the respective feature patch, and
comparing the feature values with corresponding feature values of a number of feature patches of a reference image stored in an image database, for determining a recognition of the human face.

2. A method according to claim 1, wherein at least three image patches are extracted from the image of the face, the feature patches of the image of the face being extracted from the image patches.

3. A method according to claim 2, wherein the comparing of the feature values comprises weighting the feature values as a function of the image patches.

4. A method according to claim 1, wherein the calculating of each feature value comprises summarizing image derivates for the respective feature patch.

5. A method according to claim 1, wherein the calculating of each feature value comprises summarizing at least three image derivates for the respective feature patch.

6. A method according to claim 1, wherein the calculating of the feature value for each feature patch comprises determining the integral image of the image of the face.

7. A method according to claim 1, further comprising the step of determining a number of hyper-planes from a plurality of vectors representing differences in feature values of a number of reference images.

8. A method according to claim 7, wherein the comparing of the feature values comprises determining a relationship between the hyper-planes and the features values calculated from the feature patches of the image of the face.

9. An apparatus for automatically recognizing a human face, the apparatus configured to:
retrieve an image of the face,
extract a number of feature patches from the image of the face,
calculate a feature value for each feature patch, as a function of an image-derivate of the respective feature patch, and
compare the feature values with corresponding feature values of a number of feature patches of a reference image stored in an image database, for determining a recognition of the human face.

10. An apparatus according to claim 9, wherein the apparatus is a cellular phone.

11. A computer readable medium having stored thereon a computer program having software instructions which when run on a computer cause the computer to perform the steps of:
retrieving an image of the face,
extracting a number of feature patches from the image of the face,
calculating a feature value for each feature patch, as a function of an image-derivate of the respective feature patch, and
comparing the feature values with corresponding feature values of a number of feature patches of a reference image stored in an image database, for determining a recognition of the human face.
